(19) United States
(12) Patent Application Publication
(10) Pub. No.: US 2014/0068514 A1
(43) Pub. Date: Mar. 6, 2014

(54) DISPLAY CONTROLLING APPARATUS AND DISPLAY CONTROLLING METHOD

(71) Applicant: CANON KABUSHIKI KAISHA, Tokyo (JP)

(72) Inventor: Kan Ito, Tokyo (JP)

(73) Assignee: CANON KABUSHIKI KAISHA, Tokyo (JP)

(21) Appl. No.: 14/011,144

(22) Filed: Aug. 27, 2013

(30) Foreign Application Priority Data
Sep. 6, 2012 (JP) 2012-196097

(51) Int. Cl. G06F 3/0484

(52) U.S. Cl. CPC G06F 3/04842
USPC 715/810

(57) ABSTRACT

An object of the present invention is to efficiently display and transmit information on a detected object. A display controlling system of the present invention includes: a detecting unit that detects an object from image data which an image sensing unit has read out from an image sensing device; and a display controlling unit that makes a display unit display a listing of one or more objects which the detecting unit has detected, and makes the display unit display second image data which corresponds to an object selected from the listing out of first image data which the image sensing device has generated.

### BACKGROUND OF THE INVENTION

1. Field of the Invention

The present invention relates to a display controlling apparatus and a display controlling method, and particularly relates to a technology for controlling the display of an image in response to the detection of an object.

2. Description of the Related Art

Conventionally, there has been a technology for detecting a moving object in pictures by using an image analysis technology. There further has been known a technology for following a moving object in pictures by adding a label to the moving object of a subject, which has been detected. Japanese Patent Application Laid-Open No. 2009-147479 discloses a technology for, when a moving object is detected in imaged images, extracting only image data in a specific area containing the moving object from picture data in a full screen and sending the extracted data to the outside.

As the number of objects to be detected such as the moving object increases, a processing load and a communication load for displaying all pictures of an imaged object and transmitting the pictures increase.

With respect to the above described problem, the present invention is directed at a display controlling system which can efficiently display information on a detected object and transmit the information, even when the number of objects to be detected from imaged images has increased.

### SUMMARY OF THE INVENTION

An imaging system of the present invention is a display controlling system which includes: a detecting unit that detects an object from image data which an image sensing unit has read out from an image sensing device; and a display controlling unit that makes a display unit display a listing of one or more objects which the detecting unit has detected, and makes the display unit display second image data which corresponds to an object selected from the listing out of first image data which the image sensing device has generated.

Further features of the present invention will become apparent from the following description of exemplary embodiments with reference to the attached drawings.

### BRIEF DESCRIPTION OF THE DRAWINGS

FIG. 1 is a block diagram illustrating a configuration example of an imaging system of a first embodiment according to the present invention.

FIG. 2A and FIG. 2B illustrate the first embodiment of the present invention and is a view illustrating a first example of a screen display.

FIG. 3A and FIG. 3B illustrate the first embodiment of the present invention and is a view illustrating a second example of the screen display.

FIG. 4 illustrates a second embodiment and is a block diagram illustrating a configuration example of an imaging system.

### DESCRIPTION OF THE EMBODIMENTS

Preferred embodiments of the present invention will now be described in detail in accordance with the accompanying drawings.

The present invention will be described in detail below based on its appropriate embodiments with reference to the attached drawings. Incidentally, configurations illustrated in the following embodiments are only examples, and the present invention is not limited to the illustrated configurations.

### First Embodiment

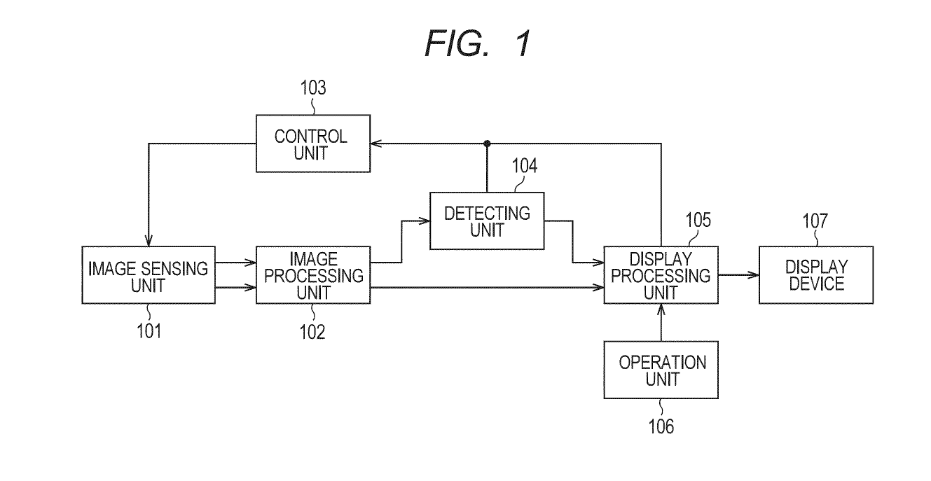

A configuration example of an imaging system to which the present invention is applied is illustrated in a block diagram of FIG. 1.

An image sensing unit 101 converts a light image which has been imaged on the image sensing plane, into a digital electric signal by photoelectric conversion. The image sensing unit 101 is configured with an image sensing device such as CMOS (Complementary Metal-Oxide Semiconductor). The image sensing unit 101 reads out image data from the image sensing device. An image processing unit 102 conducts the predetermined processing of pixel interpolation and color conversion, for the digital electric signals which have been obtained from the image sensing unit 101 by photoelectric conversion. The image processing unit 102 generates a digital image of a component system such as RGB or YUV.

In addition, the image processing unit 102 conducts predetermined arithmetic processing by using a digital image obtained after having been subjected to development, and conducts image processing such as white balance, sharpness, contrast and color conversion, based on the obtained calculation result.

A control unit 103 controls the image sensing unit 101 so as to read out pixels while thinning out the pixels at intervals of several pixels from the whole pixel range, according to the detection information sent from a detecting unit 104. When the pixels have been read out while being thinned out, the image data to be read out is image data in the whole pixel range (one screen), and contains a smaller number of pixels than the number of pixels which the image sensing unit 101 has generated in the whole pixel range. The control unit 103 controls also the image sensing unit 101 so as to partially read out the specified partial region out of the whole pixel range, according to the detection information sent from the detecting unit 104. When the pixels have been partially read out, the image data to be read out contains one part of the range out of the whole pixel range.

The detecting unit 104 detects a moving object from the digital image which has been read out by the image sensing unit 101 and has been subjected to development processing and image processing in the image processing unit 102. As a method for detecting the moving object, any method may be used such as a background difference method, an interframe difference method and a motion vector method. In a present exemplary embodiment, the case will be described where the detecting unit 104 detects the moving object as an object to be detected. However, the detecting unit 104 may also detect another object than the moving object. For instance, the detecting unit 104 may also detect an object which has predetermined characteristic quantity (shape or the like) by using a pattern matching technology. For instance, the detecting unit 104 detects a face image which matches a predetermined face image, out of a digital image. Thus, the detecting unit 104 detects the moving object out of the image data which the image sensing unit 101 has read out from the image sensing device. Furthermore, the detecting unit 104 stores a part of the detected moving object as a template and conducts the processing of following the moving object.

A display processing unit 105 conducts display processing according to the control of the control unit 103. The display processing unit 105 conducts the processing of displaying a frame for the digital image which has been read out from the image sensing unit 101 and has been subjected to the development processing and the image processing in the image processing unit 102. The display processing unit 105 conducts also the processing of arranging the digital image on a suitable position in a displayed screen. Furthermore, the display processing unit 105 conducts the processing of superimposing a list and an image which has shown a position on the screen together with an ID of the moving object that has been detected and followed in the detecting unit 104, on the above described displayed screen.

An operation unit 106 directs which moving object should be displayed on the screen out of the list of moving objects that have been detected and followed in the detecting unit 104, to the control unit 103. The image of the moving object which the operation unit 106 has directed is partially read out from the image data that the image sensing unit 101 has imaged. As an instrument for inputting an operation in the operation unit 106, for instance, a remote control, a keyboard, a mouse and the like can be used. A display device 107 displays an image which has been created in the display processing unit 105, on a display screen.

Next, details of an operation of an imaging system of the present embodiment will be described.

A state before the detecting unit 104 is started or a state in which the moving object is not detected by the detecting unit 104 shall be referred to as a usual state. In this usual state, the control unit 103 controls the image sensing unit 101 so as to operate in a first imaging mode in which the image sensing unit 101 reads out the pixels in the whole pixel range.

In the usual state, the moving object is not detected, and accordingly, if there is sufficient space for the processing, the image sensing unit 101 may read out pixels in the whole pixel range without thinning out the pixels. As a processing amount, for instance, the amount of image data can be considered which is necessary for the image processing unit 102 to conduct development processing and image processing after imaging. However, in order to increase a processing speed, the image sensing unit 101 may read out the pixels while thinning out the pixels at intervals of several pixels from the whole pixel range.

The digital image which has been imaged by the image sensing unit 101 and has been subjected to the development processing and the image processing in the image processing unit 102 is output to the detecting unit 104. If the moving object has not been detected in this digital image, the digital image is displayed in the state on the display device 107 as pictures, through the detecting unit 104 and the display processing unit 105. Thus, when the detecting unit 104 does not detect the moving object, the display processing unit 105 makes the display device 107 display the first image data in the whole pixel range, which the image sensing device has read out.

Next, the processing in the case where the moving object has been detected in pictures imaged by the image sensing unit 101 will be described.

Suppose that the detecting unit 104 has detected the moving object in the usual state, while the image sensing unit 101 is reading out pixels in the whole pixel range.

When the moving object has been detected, the detecting unit 104 follows the moving object. The detecting unit 104 associates the ID with the moving object to be followed, and sends detection information which includes the ID and a positional information that shows a position of the moving object in an imaged image, to the control unit 103 and the display processing unit 105. When the image sensing unit 101 has read out all pixels in the whole pixel range without thinning out pixels, the control unit 103 controls the image sensing unit 101, and makes the image sensing unit 101 switch the readout processing for image data so as to read out image data in the whole pixel range while thinning out pixels at intervals of several pixels. Thus thinned-out image in the whole pixel range is used for the detecting unit 104 to detect the position of the moving object in the whole pixel range and follow the moving object. A detection result of the detecting unit 104 is used for the display unit to display the image on the display screen, which shows the position of the moving object in the whole pixel range.

Furthermore, the control unit 103 sets a partial region that corresponds to a portion out of the whole pixel range, in which the moving object has been detected, based on the detection information including positional information. Then, the control unit 103 controls the image sensing unit 101 so as to read out image data from the set partial region without thinning out pixels. When the imaging system operates in a second imaging mode, the control unit 103 controls the image sensing unit 101 so as to carry out readout processing for pixels in the whole pixel range while thinning out pixels and readout processing for pixels in the partial region without thinning out pixels, by time-division switching. Thus, the image sensing unit 101 conducts the processing of reading out third image data of which the imaging range corresponds to that of the image data (first image data) that has been read out from all pixels in the image sensing device, and which contains less number of pixels than that of the first image data, from the image sensing device. The image sensing unit 101 also conducts the processing of reading out second image data which corresponds to the moving object that has been selected from the listing out of the first image data. When a plurality of moving objects has been detected, the control unit sets the region of the moving object which has been firstly detected, as a partial region which the image sensing unit 101 reads out, and controls the image sensing unit.

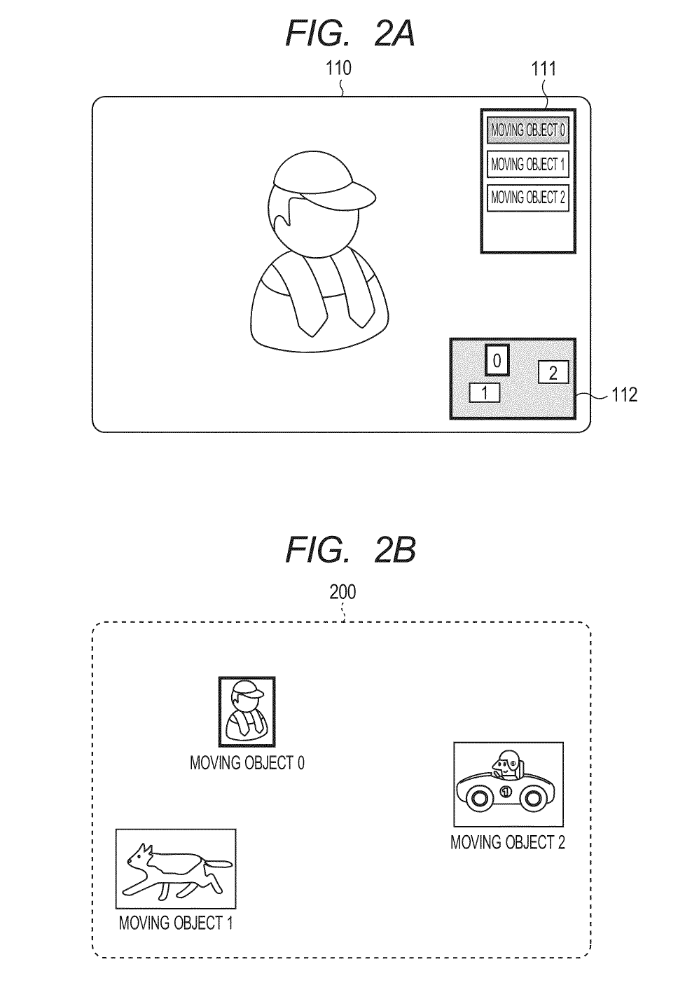

On the other hand, the display processing unit 105 which has received a notification of the detection information that includes the positional information together with the ID of the moving object obtains the positional information from the input detection information. Then, the display processing unit 105 displays information which shows the position of the moving object in the whole pixel range, on the display device 107, based on the obtained positional information. In the present embodiment, the display processing unit 105 creates a list of the ID of the moving object and an image which shows the position of each moving object on the screen, and makes the display device 107 display the list and the image thereon. Thus, the display processing unit 105 makes the display device 107 display the listing of one or more moving objects which the detecting unit 104 has detected. FIG. 2A illustrates a screen 110 as an example of a screen to be displayed on the display device 107. The list 111 in FIG. 2A is a list of the IDs of the moving objects which the detecting unit 104 has detected. In addition, an image 112 in FIG. 2A is an image which shows the respective positions of the moving objects in the whole pixel range. Thus, the display processing unit 105 makes the display device 107 display the information that shows the respective positions at which the moving objects have been detected, as the listing, on its display screen. The display device 107 displays a picture of the moving object which corresponds to the set partial region, on its display screen. The display processing unit 105 highlights items (which are shown by frames of thick line in FIG. 2A and FIG. 2B) of the moving object that corresponds to the partial region set up through the operation unit 106, in the list 111 of the IDs of the moving objects and the image 112 which shows the respective positions of the moving objects in the whole pixel range.

A dotted line 200 in FIG. 2B illustrates the whole pixel range of the image sensing unit 101, and corresponds to a range based on which the detecting unit 104 detects the moving object. Suppose that when the screen 110 in FIG. 2A is displayed on the display device 107, a user has selected another item of the moving object which is not highlighted in the list 111 or in the image 112. For instance, suppose that the user has selected a “moving object 0” through the operation unit 106, in the list 111, or in the image 112 which shows the position on the screen (whole pixel range), in the screen 110.

The display processing unit 105 which has received the direction from the operation unit 106 sets a partial region that is read out by the image sensing unit 101, based on detection information including positional information of the moving object which the user has selected, and controls the image sensing unit. The imaging system reads out the partial region of the corresponding moving object from the image sensing unit 101, images the moving object, subjecting the images to development processing and image processing in the image processing unit 102, and outputs the result to the display processing unit 105. Thus, when the detecting unit 104 has detected the moving object, the display processing unit 105 controls the display device 107 so as to display the second image data that corresponds to the selected moving object out of the first image data which the image sensing device has generated.

The imaging system superimposes an image which shows the list and the position of the moving objects on the screen together with the ID of the moving object which has been highlighted on the item of the corresponding moving object, on a picture which has been input into the display processing unit 105, and makes the display device 107 display the resultant picture thereon. The above described example is an example in which the display device 107 highlights one moving object 0 thereon, but of course, it is also possible to make the display device 107 highlight a plurality of moving objects.

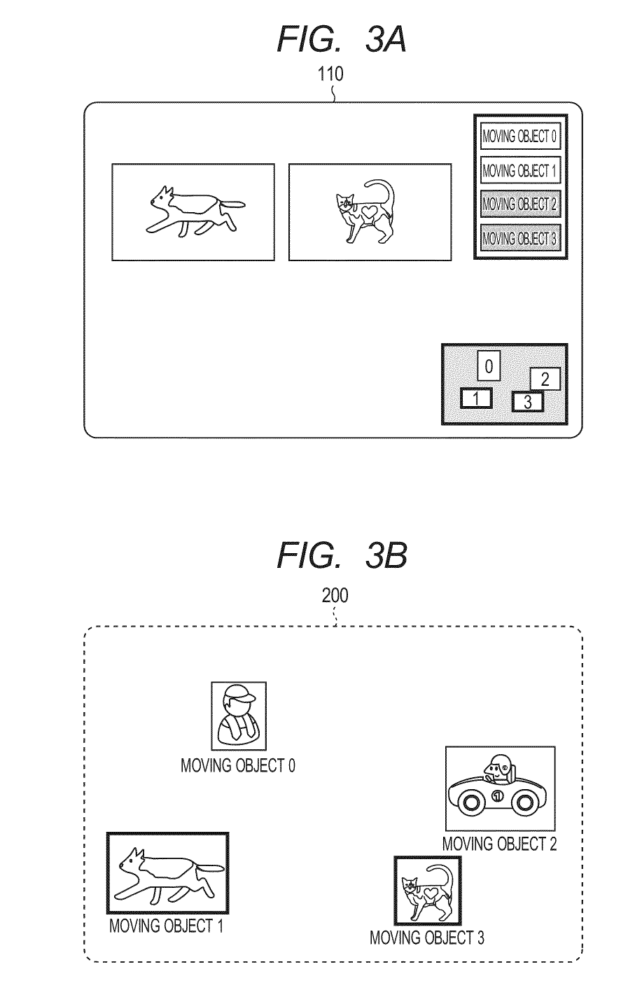

FIG. 3A illustrates an example of a screen in which a plurality of the moving objects are selected and displayed on the display device 107. FIG. 3A illustrates a picture of the moving objects, in which the moving objects 1 and 3 of the subjects are set as a partial region to be read out by the image sensing unit 101, and the items of the list are highlighted together with the respective IDs of the moving objects. FIG. 3B illustrates an image which shows the respective positions of the moving objects 1 and of the subjects on the screen, and the corresponding moving objects 1 and 3 are highlighted.

According to the imaging system of the present exemplary embodiment, a user can select a picture of a desired moving object and the picture of the moving object can be efficiently displayed or transmitted.

### Second Embodiment

Next, a second embodiment will be described which has been configured so that the imaging system to which the present invention is applied can transmit a picture to the outside.

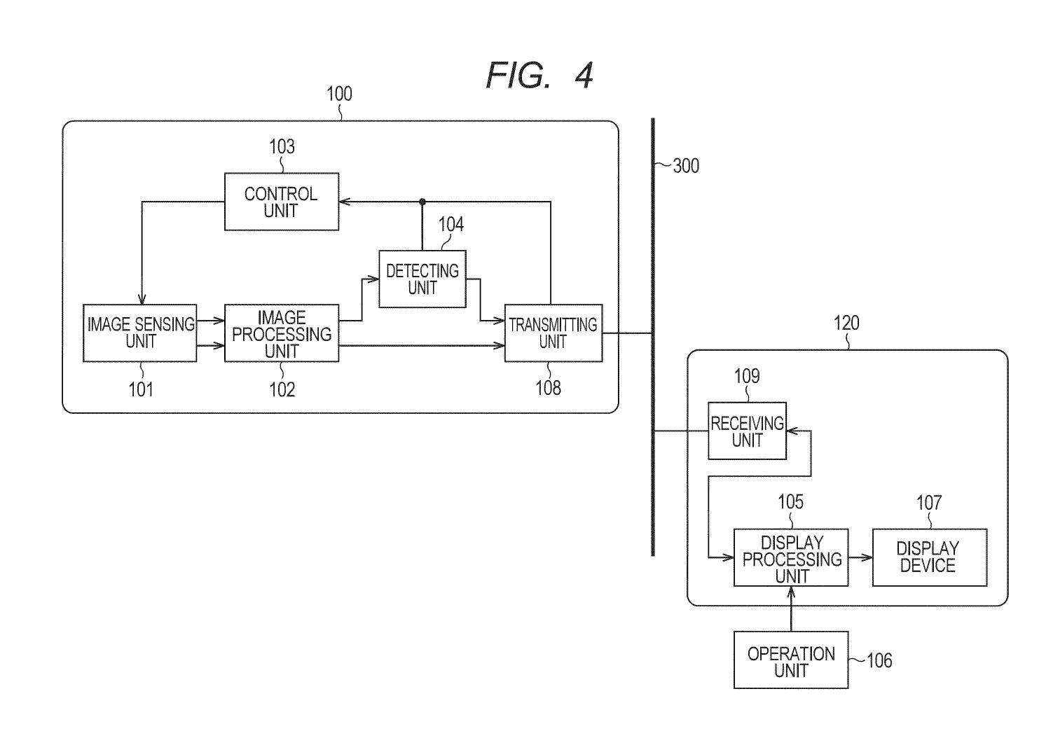

FIG. 4 is a block diagram illustrating a configuration example of the imaging system which can transmit the picture to the outside.

In FIG. 4, a transmitting device 100 transmits a picture which has been imaged by the image sensing unit 101 to the outside of the network. The transmitting device 100 shows, for instance, a network camera body or the like.

A receiving terminal 120 receives a picture which has been transmitted from the transmitting device 100, and the display device 107 (display unit) displays the picture. Components including the image sensing unit 101 to the display device 107 have the same functions as having been shown in the above described imaging system. A transmitting unit 108 packetizes the picture information which has been coded by the transmitting device 100, into a video packet, and transmits the information to LAN (Local Area Network) 300. The receiving terminal 120 has an information receiving unit 109 provided therein which depacketizes the video packet that the information receiving unit 109 has received from the LAN 300 and forms the coded picture. The image sensing unit 101, the image processing unit 102, the control unit 103, the detecting unit 104, the display processing unit 105, the operation unit 106 and the display device 107 in FIG. 4 are configured to have the same functions as having been shown in the above description, and detailed description will be omitted for the equal configuration.

In the configuration illustrated in FIG. 4, also on the display device 107 in the receiving terminal 120, the pictures are displayed as in the screens illustrated in FIG. 2 and FIG. 3. Of course, when a user has selected an item of another moving object which is not highlighted, a notification that another moving object has been selected is transmitted to the image sensing unit 101 in the transmitting device 100 through the LAN 300. The image sensing unit 101 which has received the notification sets the partial region to be read out, and the control unit controls the image sensing unit.

Thus, the transmitting device 100 reads out the partial region of the selected moving object from the image sensing unit 101, conducts development processing and image processing in the image processing unit 102, and creates the picture information. Then, the transmitting device 100 transmits the created picture information to the receiving terminal 120 through the transmitting unit 108. On the display device 107, a picture is displayed in which the list and an image that shows the respective positions of the moving objects on the screen are superimposed together with the IDs of the moving objects. Thus, the transmitting device transmits the image data of the region which corresponds to the moving object that has been selected from the listing out of the image data which the image sensing device has generated, to the display device 107 (display unit) in the receiving terminal 120 through the network. The transmitting device also transmits the information that shows the position at which the moving object has been detected in the image data that the image sensing device has generated, to the display device 107 (display unit) through the network.

The above described configuration enables the imaging system to work in the similar way to the above description through the LAN 300, by an operation directed from the operation unit 106 in the receiving terminal 120. The number of these transmitting devices 100 and the receiving terminals 120 is not limited to one as is illustrated in FIG. 4, and many transmitting devices and receiving terminals may exist as long as the devices and the terminals can be discriminated from each other by the respective addresses or the like.

The LAN 300 also is not limited, and any network can be used such as an internet or an intranet having a sufficient band to let the packet data pass therethrough. The physical connection configuration to the LAN 300 can be not only the case of a cable but also the case of radio. However, the physical configuration may not be stuck to as long as the transmitting device and the LAN 300 are connected according to the protocol.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-196097, filed Sep. 6, 2012, which is hereby incorporated by reference herein in its entirety.

What is claimed is:

1. A display controlling system comprising:
a detecting unit configured to detect an object from image data read out from an image sensing device by an image sensing unit; and
a display controlling unit configured to allow a display unit to display a listing of one or more objects detected by the detecting unit, and to allow the display unit to display second image data corresponding to an object selected from the listing out of first image data generated by the image sensing device.

2. The display controlling system according to claim 1, wherein the display controlling unit allows the display unit to display the information as the listing, the information indicating a position on the first image data at which the object has been detected.

3. The display controlling system according to claim 1, further comprising:
a transmitting unit configured to transmit, to the display unit through a network, the second image data corresponding to the object selected from the listing out of the first image data generated by the image sensing device.

4. The display controlling system according to claim 1, further comprising:
a transmitting unit configured to transmit, to the display unit through a network, information indicating a position at which the object has been detected in the first image data generated by the image sensing device.

5. The display controlling system according to claim 1, wherein the display controlling unit allows the display unit to display the first image data in a case that the detecting unit has not detected an object, and allows the display unit to display the second image data in a case that the detecting unit has detected an object.

6. The display controlling system according to claim 1, further comprising:
an image sensing unit configured to read out image data from the image sensing device, wherein:
the image sensing unit executes a process of reading out third image data from the image sensing device, the third image data having an imaging range corresponding to the first image data and having a smaller number of pixels than that of the first image data, and executes a process of reading out the second image data from the image sensing device, the second image data corresponding to an object selected from the listing out of the first image data;
the detecting unit detects an object from the third image data; and
the display controlling unit allows the display unit to display the second image data.

7. A transmitting device comprising:
a detecting unit configured to detect an object from image data read out from an image sensing device; and
a transmitting unit configured to transmit, to a display apparatus, a listing of one or more objects detected by the detecting unit, and to transmit, to the display apparatus, second image data corresponding to an object selected from the listing out of first image data generated by the image sensing device.

8. The transmitting device according to claim 7, wherein the transmitting unit transmits the first image data to the display apparatus in a case that the detecting unit has not detected an object, and transmits the second image data to the display apparatus in a case that the detecting unit has detected an object.

9. A display controlling method comprising:
a detecting step of detecting an object from image data read out from an image sensing device by an image sensing unit;
a first display controlling step of allowing a display unit to display a listing of one or more objects detected at the detecting step; and
a second display controlling step of allowing the display unit to display second image data corresponding to an object selected from the listing out of first image data generated by the image sensing device.

10. The display controlling method according to claim 9, the first display controlling step further comprising:
allowing the display unit to display the information as the listing, the information indicating a position on the first image data, at which the object has been detected.

11. The display controlling method according to claim 9, further comprising:
a transmitting step of transmitting, to the display unit through a network, the second image data corresponding to the object selected from the listing out of the first image data generated by the image sensing device.

12. The display controlling method according to claim 9, further comprising:
a transmitting step of transmitting, to the display unit through a network, information indicating a position at which the object has been detected in the first image data generated by the image sensing device.

13. The display controlling method according to claim 9, further comprising:
a third display controlling step of allowing the display unit to display the first image data, wherein,
the display unit is allowed to display the second image data at the second display controlling step in a case that the object has been detected at the detecting step, and
the display unit is allowed to display the first image data at the third display controlling step in a case that the object has not been detected at the detecting step.

14. A transmitting method comprising:
a detecting step of detecting an object from image data read out from an image sensing device;
a first transmitting step of transmitting, to a display apparatus, a listing of one or more objects detected in the detecting step; and
a second transmitting step of transmitting, to the display apparatus, second image data corresponding to an object selected from the listing out of first image data generated by the image sensing device.

15. A transmitting method according to claim 14, further comprising:
a third transmitting step of transmitting the first image data to the display apparatus, wherein,
the second image data is transmitted to the display apparatus at the second transmitting step in a case that the object has been detected in the detecting step, and
the first image data is transmitted to the display apparatus at the third transmitting step in a case that the object has not been detected in the detecting step.

16. A non-transitory computer-readable storage medium that stores computer-executable instructions comprising:
a detecting step of detecting an object from image data read out from an image sensing device;
a first transmitting step of transmitting, to a display apparatus, a listing of one or more objects detected in the detecting step; and
a second transmitting step of transmitting, to the display apparatus, second image data corresponding to an object selected from the listing out of first image data generated by the image sensing device.

17. The storage medium according to claim 16, further comprising:
a third transmitting step of transmitting the first image data to the display apparatus, wherein
the second image data is transmitted to the display apparatus at the second transmitting step in a case that the object has been detected in the detecting step, and
the first image data is transmitted to the display apparatus at the third transmitting step in a case that the object has not been detected in the detecting step.
